(19) United States
(12) Patent Application Publication
(10) Pub. No.: US 2002/0141668 A1
(43) Pub. Date: Oct. 3, 2002

(54) Multiple spiral bearing steel ball sleeve

(76) Inventor: En Te Chu, Taichung (TW)

Correspondence Address: DOUGHERTY & TROXELL, SUITE 1404, 5205 LEESBURG PIKE, FALLS CHURCH, VA, 22041, US

(21) Appl. No.: 09/801,703

(22) Filed: Mar. 9, 2001

(51) Int. Cl. F16C 29/04

(52) U.S. Cl. 384/49

(57) ABSTRACT

This invention provides a multiple spiral bearing steel ball sleeve. The steel ball sleeve is a hollow tube. On the tube wall are multiple through holes evenly distributed. The holes closely spaced from each other and arranged in inclined surface and in spiral lines. Steel balls are placed inside the holes, so the entire set of steel ball sleeve can withstand a reduced pressure to extend its service life.

### BACKGROUND OF THE INVENTION

This invention relates to the structure of a steel ball sleeve, particularly a structural improvement of multiple spiral bearing steel ball sleeve that will withstand reduced pressure and enhance its working efficiency.

As shown in FIGS. 1, 2 and 3, conventional machining involves a steel ball sleeve 1 that covers a module in order to reduce friction, especially in punching press modules. However, conventional the steel ball sleeve 1 has the following shortcomings in its application:

Insufficient bearing points, resulting in increased bearing pressure.

Uneven contact surface, resulting in friction on a same position, and subsequent wear and tear.

Damage to the body itself of conventional steel ball sleeve 1 will cause increased friction coefficient when it is sliding, and produce more resistance.

Early wear and tear result in shortened service life and frequent replacement of parts hence reduced working efficiency.

Because of consistently reciprocal movement of upper mold of guide sleeve and lower mold of guide post on machine base, the steel ball sleeve 1 being loaded inside the guide sleeve, and because of the movement of the rolling slide track, the steel ball sleeve 1 will turn and move inside the guide sleeve. In a conventional steel ball sleeve 1, a specified number of steel balls are loaded on a same elevation of the cylinder, the guide sleeve will show several lines of wear after extended use, resulting in enlarged distance between upper and lower molds and damage to the molds.

### BRIEF DESCRIPTION OF THE INVENTION

The main objective of this invention is to employ the design of this invention of steel ball sleeve to achieve the objective of extended service life and upgraded working efficiency, to improve on the shortcomings of conventional types, enhance the value of use by manufacturers, and upgrade their economic efficiency.

Based on the above, this invention of multiple spiral bearing steel ball sleeve involves a hollow cylinder of the steel ball sleeve. On the wall of the cylinder are multiple through holes evenly distribute around the cylinder. The holes are closely spaced from each other, and arranged in inclines and spiral lines. The steel balls are placed inside the holes to reduce bearing pressure on the entire set of steel balls, and extend their service life.

Moreover, without affecting the structure, the distance between holes is minimized to increase the number of steel balls, increase the number of bearing points and decrease the bearing pressure on each point.

### BRIEF DESCRIPTION OF DRAWINGS

The drawings of preferred embodiments of this invention are described in following details to enable better understanding.

FIG. 1 is a schematic view of a prior art.

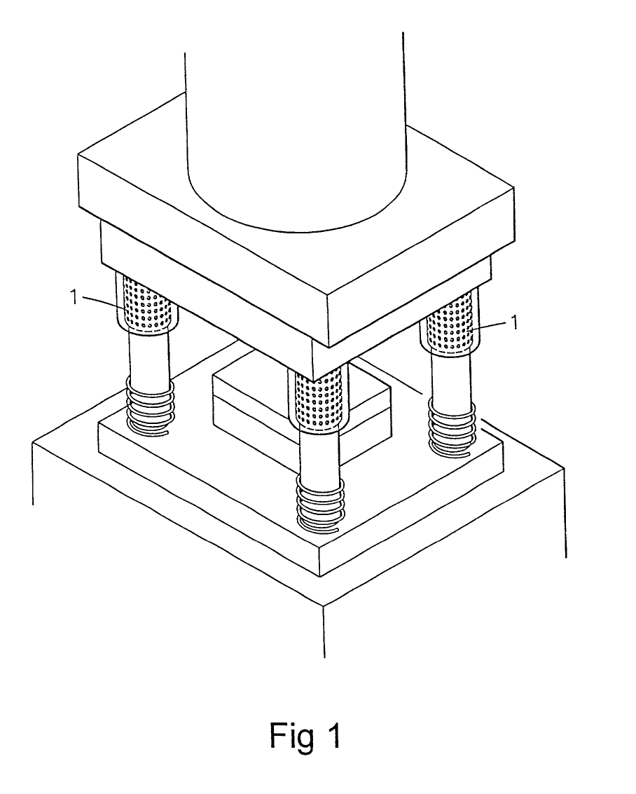

FIG. 2 is a perspective view of the prior art.

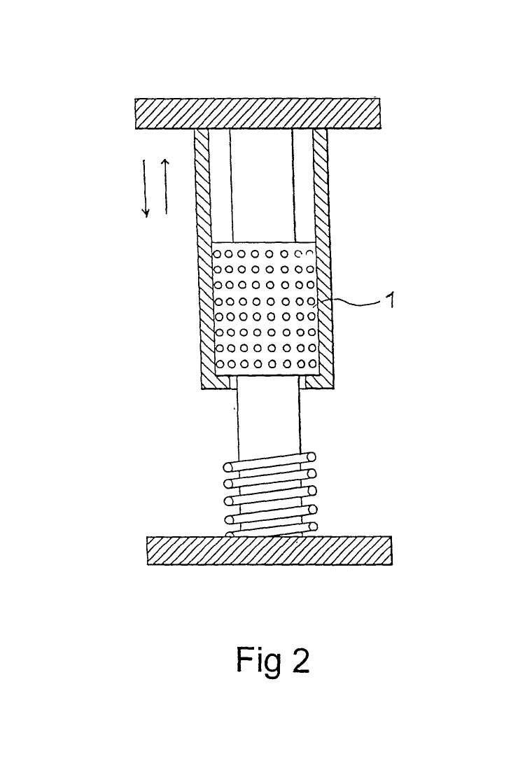

FIG. 3 is a plane view of the prior art.

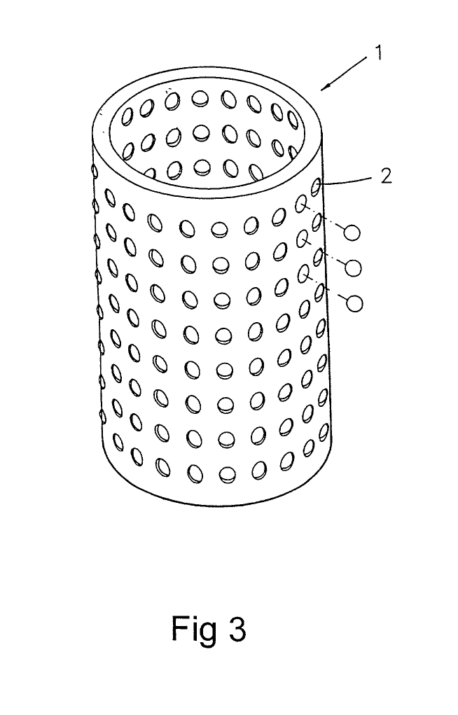

FIG. 4 is a perspective view of this invention.

FIG. 5 is a perspective view of the assembly of this invention.

FIG. 6 is a plane view of this invention.

FIG. 7 is a view comparing the prior art with this invention.

BRIEF DESCRIPTION OF NUMERALS

| | |
|---|---|
| (1) steel ball sleeve | (2) hole |
| (10) steel ball sleeve | (11) hole |
| (20) Steel balls | |

### DETAILED DESCRIPTION OF PREFERRED EMBODIMENTS

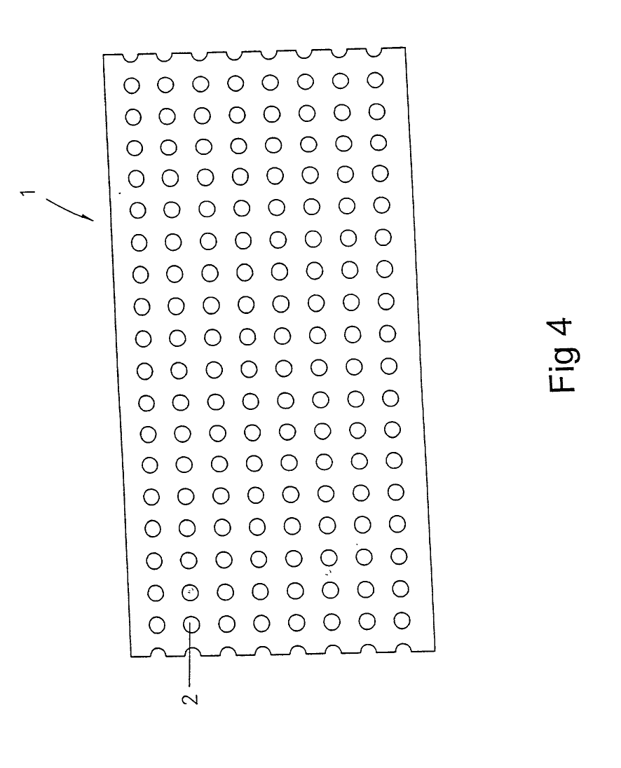

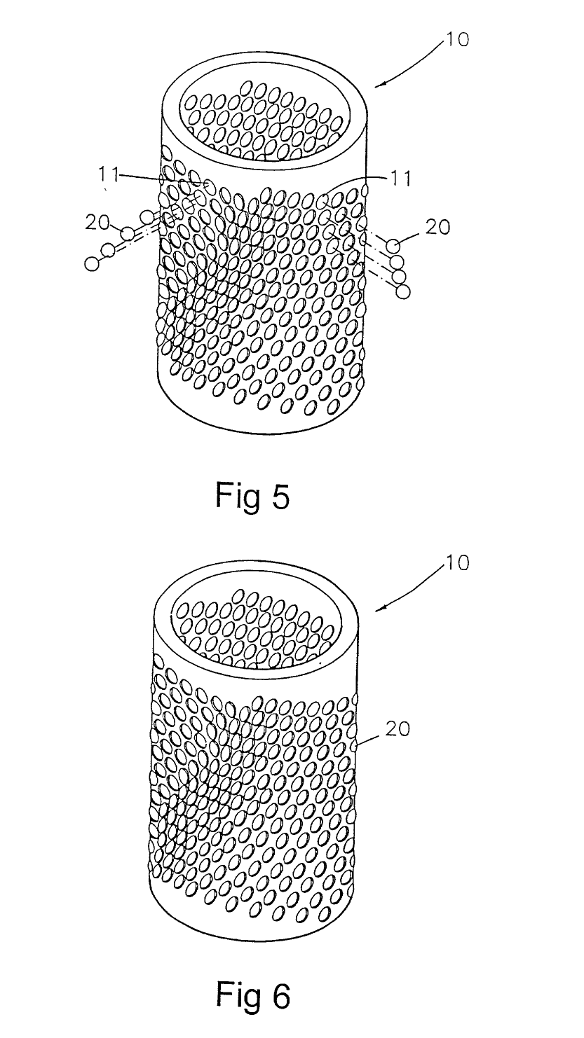

As shown in FIGS. 4 and 5, the invention of multiple spiral shaft sleeve is characterized in that:

The steel ball sleeve 10 is a hollow cylinder, on the wall of the cylinder are multiple through holes 11 distributed all over the enter cylinder wall. The through holes 11 are closely spaced from each other, and are arranged in a spiral, inclined line. Steel balls 20 are put inside the through holes 11, so the whole set of steel ball sleeve 20 will undertake a reduced pressure to extend its service life.

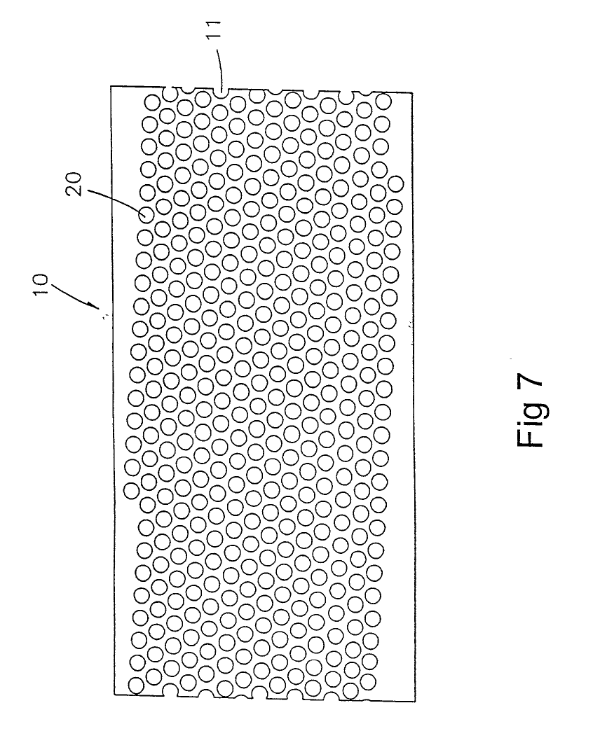

As shown in FIGS. 6 and 4, this invention is made in a way that, first; a specified section of tube is cut; on the wall of the tube, the spacing of the holes 11 are measured and positioned in the arrangement of a spiral line, and depending on the incline of the wall surface providing a larger accepting incline, so the pressure to be undertaken can be reduced.

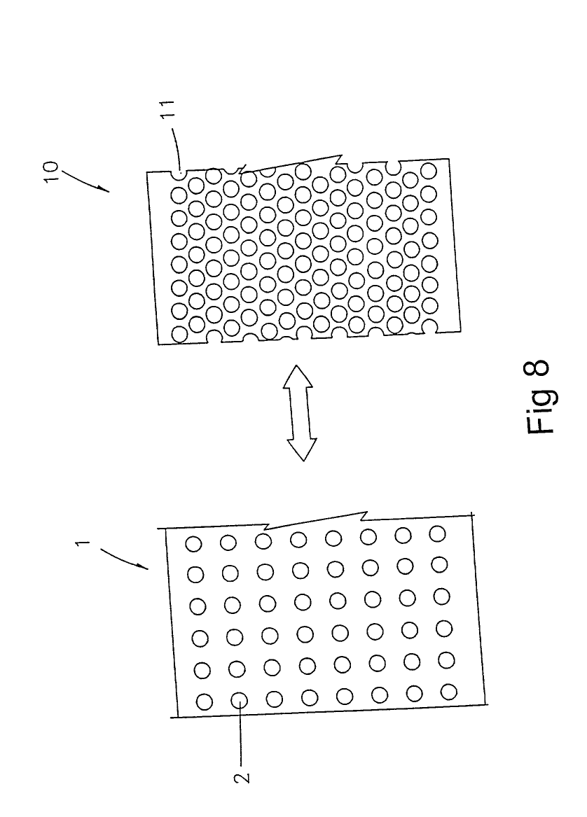

Furthermore, as compared in FIG. 7, the section on the left refers to a prior art of steel ball sleeve 1, while the section on the right refers to this invention of steel ball sleeve 10. It is clearly shown that the distance between each two holes 2 in the conventional steel ball sleeve 1 is larger, and their alignment is very neat, that is, the lines are parallel and vertical. Such a design causes increased friction to its module, so the steel ball sleeve 1 will be broken and damaged when it could not effectively withstand the bearing pressure. Meanwhile, the design of this invention of steel ball sleeve 10 decreases the distance between the holes 11 that are arranged in a spiral line, so it has more bearing points, increased bearing pressure, and extended service life. For instance, suppose the prior art has 10 bearing points to support 100 Kg, then the pressure applied on each point is 10 Kg. This invention has 20 points to support 100 Kg, so the bearing pressure on each point is 5 Kg.

The prior art: 100 Kg=10 points→pressure on each point=10 Kg

This invention: 100 Kg=20 points→pressure on each point=5 Kg

Therefore, this invention has reduced bearing pressure on each point because it has increased its bearing points, which will result in extended service life and relatively higher working efficiency.

On point worth mention is that, the structural design of this invention is different from the conventional type and single-spiral type of steel ball sleeve. In a single-spiral type, when it withstands a abrupt lateral force, there is only one steel ball to withstand the lateral force at its point of maximum impact. This invention of multiple spiral type can be designed to have double spiral (180° ), three-spiral (120° ), four-spiral (90° ), etc., so that the lateral pressure is evenly distributed on each steel ball, which results in extended service life to the steel ball sleeve, the guide sleeve and the guide post.

Working performance can be enhanced especially in applications of this invention including punching press bench (high speed up-and-down movement), production machines, continuous punching press, food machines and working machines involved in reciprocal movement,

Therefore, this invention will not only improve on the conventional structure of steel ball sleeve, but will also has better applicability and convenience, so its practical inventiveness is highly affirmed.

Advantages of this invention can be grouped as follows:

Increased bearing points and reduced pressure on each point.

Extended service life and enhanced economic efficiency.

Enlarged and even contact surface to resist wear and tear.

Suitable for machining by various machines, especially high RPM modules.

No need of frequency replacement and upgraded working efficiency.

What is claimed is:

1. This invention provides a multiple spiral bearing steel ball sleeve. The steel ball sleeve is a hollow tube. On the tube wall are multiple through holes evenly distributed. The holes closely spaced from each other and arranged in inclined surface and in spiral lines. Steel balls are placed inside the holes, so the entire set of steel ball sleeve can withstand a reduced pressure to extend its service life.
